(19) United States
(12) Patent Application Publication
(10) Pub. No.: US 2006/0160544 A1
(43) Pub. Date: Jul. 20, 2006

(54) Distance dependent direct mode peer -to-peer communication establishment in a tdd cdma network

(76) Inventors: Li Sun, Shanghai (CN); Ni Ma, Shanghai (CN); Jiang Cheng, Shanghai (CN); Qunli Jia, Shanghai (CN); Xuejun Zhang, Shanghai (CN); Sheng Pan, Shanghai (CN); Fang Peng, Shanghai (CN); Yonggang Du, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/547,583

(22) PCT Filed: Feb. 24, 2004
(86) PCT No.: PCT/IB04/50137

§ 371 Date: Sep. 1, 2005

(30) Foreign Application Priority Data
Mar. 7, 2003 (CN) 031198929

(51) Int. Cl. H04Q 7/20

(52) U.S. Cl. 455/456.1

(57) ABSTRACT

A method for establishing P2P (peer-to-peer) communication in wireless communication networks, comprising steps of: determining whether two user equipments (caller and call) are in the same cell, and computing whether the distance between the two user equipments (UEs) meets the requirement for P2P communication according to the registry information and position information of the caller and the callee; determining whether the two UEs both have P2P communication capability according to the information of the wireless communication system indicating whether the two UEs both have P2P communication capability, when the two UEs are in the same cell and the distance between the two UEs meets the requirement for P2P communication; and allocating direct communication link for the two UEs to start communication when the two UEs both have P2P communication capability.

### FIELD OF THE INVENTION

The present invention relates generally to a method and apparatus for establishing Peer-to-Peer communication in wireless communication networks, and more particularly, to a method and apparatus for establishing P2P communication in TDD CDMA wireless communication networks.

### BACKGROUND OF THE INVENTION

In conventional cellular communication systems, regardless of the distance between two communicating user equipments (UEs), a UE has to communicate with another UE only through the relaying of a base station. FIG. 1 illustrates the conventional communication mode, where UE1 and UE2 communicate with each other through the UTRAN (Universal mobile telecommunications system Terrestrial Radio Access Network) consisting of the base station transceiver (namely Node B) and the RNC (Radio Network Controller), and this communication mode is also called UP-UTRAN-DOWN mode. However, under some circumstances when two UEs are very close in the same cell, it can be a more reasonable way for them to communicate directly, rather than being relayed/forwarded by base stations. This method is the so-called peer-to-peer communication, abbr. as P2P.

FIG. 2 illustrates a P2P communication mode, where the dashed line represents signaling link, the solid line represents data link, and the arrowhead represents the direction of information flow. There is only signaling link between the UTRAN and the UEs, while only data link exists between two communicating UEs. Let's suppose only resource for maintaining basic communication is needed. If a direct link is taken as a radio resource unit (having fixed frequency, timeslot and spreading code), it can be easily inferred that P2P communication mode only needs two radio resource units to maintain basic communication. If some additional signaling overheads are ignored, P2P communication can save about 50% radio resource than conventional communication mode. Meanwhile, the UTRAN still keeps control over P2P communication, especially over how to use radio resources, such that network operators can easily charge for the radio resource used by the P2P communication.

As described above, it's necessary to apply P2P communication in current systems. However, considering cost and many other factors, significant modifications to existing systems are not desirable during implementation and it's better to reuse most existing modules. From this perspective, P2P communication is most applicable to TDD CDMA system In current 3G mobile communication systems, because TDD mode can carry out P2P communication without additional RF transceiver and all modifications needed are related with higher-layer protocols while physical layer structures can still be reused. Thus, existing communication systems will easily support P2P mode though software upgrade without making modifications to the hardware.

### SUMMARY OF THE INVENTION

It is therefore, an object of the present invention to provide a method and apparatus for establishing P2P communication in wireless communication networks. This method and apparatus can enable P2P communication between two UEs who are very close, thus greatly save radio resource than conventional communication mode. Furthermore, only high-layer protocol software modules need to be modified to implement this method, which fully reuses hardware modules of existing communication systems.

To achieve the above object, a method and apparatus for establishing P2P communication in wireless communication systems is proposed in this invention, comprising:

determining whether the two UEs (caller and callee) are in the same cell according to the registry information and position information of the caller and the callee, and computing whether the distance between them meets the requirement for P2P communication;

determining whether the two UEs both have P2P communication capability according to the information provided by the wireless communication system indicating whether the caller and the callee both have P2P communication capability, when the two UEs are in the same cell and the distance between them meets the requirement for P2P communication;

allocating direct communication link for the two UEs to perform P2P communication when the caller and the callee both have P2P communication capability.

This invention proposes a method for establishing P2P communication in wireless communication networks, wherein the position information of the caller is contained in the call request sent by the caller to the wireless communication system, and the position information of the callee is contained in the call response sent by the callee to the wireless communication system.

To achieve the above object, the present invention proposes a method for the UE to establish P2P communication in an UE, comprising:

communicating directly via the allocated direct communication link, after the wireless communication system has allocated direct communication link to the UE, according to the registry information, position information of the UE and the information of the wireless communication systems about whether the UE has the P2P communication capability.

This invention proposes a method for the UE to establish P2P communication, wherein the position information of the UE can be included in the call request sent by the UE to the wireless communication system, or in the call response sent by the UE to the wireless communication system.

To achieve this object, the present invention proposes an apparatus for the wireless communication system to establish P2P communication, comprising: a computing unit, for judging whether the two UEs (caller and callee) are in the same cell according to the registry information and position information of the caller and the callee, and computing whether the distance between them meets the scope requirement for P2P communication; a judging unit, for determining whether the two UEs both have P2P communication capability according to the information of the wireless communication system indicating whether the caller and the callee both have P2P communication capability, when the two UEs are in the same cell and the distance between the two UEs meets the requirement for P2P communication; an allocating unit, for allocating direct communication link for the two UEs to start P2P communication when the caller and the callee both have P2P communication capability.

The apparatus for the wireless communication system to establish P2P communication as proposed in this invention, may further comprise: a call request responding unit, for receiving and responding to a call request when the call request sent by a caller to the wireless communication system contains the position information of the caller; a paging response receiving unit, for receiving and responding to a call response when the call response sent by the callee to the wireless communication system contains the position information of the callee.

To achieve the above object, a UE is proposed in this invention, comprising: an RF unit, for receiving or transmitting radio signals; a data processing unit, for processing the radio signals received by the RF unit and the signals to be transmitted by the RF unit; a baseband processing unit, for controlling the RF unit and the data processing unit to directly communicate via the allocated direct communication link after the wireless communication system allocates direct communication link to it according to the registry information and position information of the UE and the information of the wireless communication system about the P2P communication capability of the UE.

The UE proposed in this invention may further comprise: a calling unit, for sending a call request containing the position information of the UE to the wireless communication system when the UE acts as a caller; a responding unit, for sending a call response containing the position information of the UE to the wireless communication system when the UE acts as a callee.

### BRIEF DESCRIPTION OF THE DRAWINGS

FIG. 1 is a schematic diagram illustrating a TDD CDMA system employing conventional communication mode;

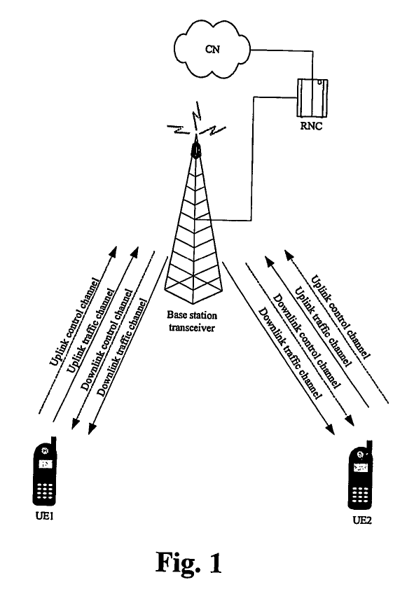

FIG. 2 is a schematic diagram illustrating a TDD CDMA system employing P2P communication mode;

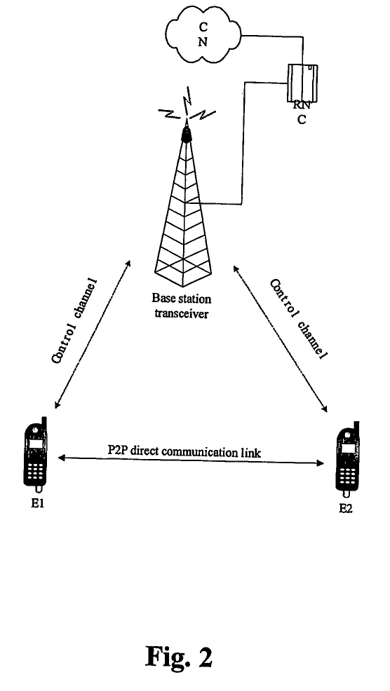

FIG. 3 illustrates the structure of a UE employing P2P communication mode;

FIG. 4 illustrates the flowchart of a TDD CDMA system employing P2P communication mode.

### DETAILED DESCRIPTION OF THE INVENTION

In order to clarify the P2P communication method used in TDD CDMA systems, firstly it's necessary to redefine the operation modes of the UE.

It's well known that two different operation modes are defined for the UE in conventional TDD CDMA systems: IDLE mode and CONNECT mode. After powering on, the UE stays in IDLE mode until it sends a request to establish an is RRC (Radio Resource Control) connection. When the RRC connection is established, the UE enters CONNECT mode. When the RRC connection is released or fails, the UE leaves CONNECT mode to return to IDLE mode.

The entities of an RRC connection involve both the UE and the UTRAN. However, when P2P communication is enabled, the entities of direct communication only involve the communicating UEs. Without any dedicated link with the UTRAN, the UE's operation mode does not fit IDLE mode or CONNECT mode, and in this situation, a specific mode should be introduced. We can call the new operation mode in the present invention as direct mode.

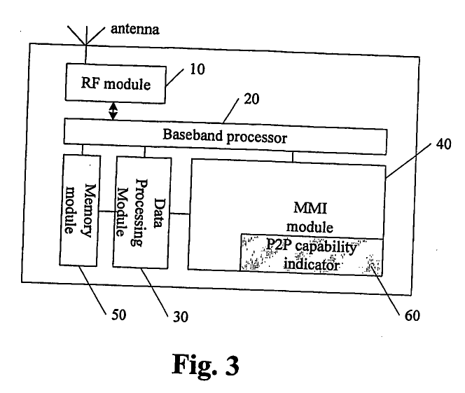

To enable P2P communication and send an indication for enabling P2P communication to the UTRAN, the UE should have a module for indicating its P2P communication capability. FIG. 3 is a block diagram illustrating the structure of a UE with this module. As shown in the figure, the UE comprises an RF module 10, a baseband processor 20, a data processing module 30, an MMI (Man-Machine Interface) module, and a memory module 50. The RF module consists of a transceiver, a modulator and a demodulator. The RF unit has its own RF carrier. An input/output of the transceiver is coupled to an antenna, an output of the transceiver is coupled to an input of the demodulator and an input of the transceiver is coupled to an output of the modulator. The baseband processor can control and communicate with other modules. The MMI includes a P2P communication capability indicator 60, and the indicator could be implemented in either hardware, for instance, a keystroke or a switch, or software (for instance, an item in setting menu).

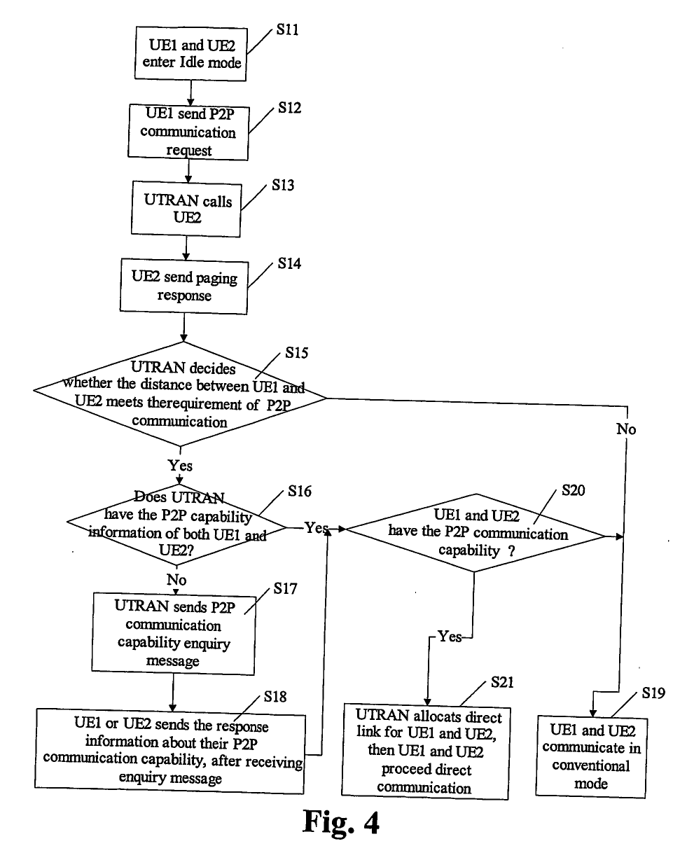

Referring to FIG. 4, detailed description of the P2P communication method for TDD CDMA systems proposed in the invention will be given below, as following steps:

1. UE1 or UE2 enters IDLE mode (S11)

When UE1 or UE2 is powered on, it selects a public land mobile network (PLMN) first and then searches for a suitable cell of this PLMN to camp on.

During the cell search procedure, the UE establishes downlink synchronization and reads the broadcast channel for system information. After cell search, the UE enters and stays in IDLE mode.

2. UE1 sends call request (S12)

When UE1 wants to communicate with UE2 in the same cell, it initiates random access procedure via common control channel, by sending call request to the UTRAN to obtain radio resource, wherein the request message may include P2P communication requirement, the indication for whether UE1 has P2P communication capability, as well as the position information about UE1's location.

After random access procedure, UE1 moves to CONNECT mode, that is, a signaling connection is established between UE1 and the UTRAN.

3. The UTRAN calls UE2 (S13)

After receiving the call request from UE1, the UTRAN sends a paging message to UE2 via the paging control channel.

4. UE2 sends paging response (S14)

UE2 can monitor its own PICH (Paging Indication Channel) and PCH (Paging Channel) when it is in IDLE mode and will not miss any paging message from the UTRAN. After receiving the paging message, UE2 will respond to the UTRAN by sending a paging response, and the response message may include the indication for whether UE2 has P2P communication capability, as well as the position information about UE2's location.

After responding to the UTRAN, UE2 also enters CONNCET mode, that is, a signaling connection is also established between UE2 and the UTRAN.

5. Check whether the distance between UE1 and UE2 meets the requirement for P2P communication (S15)

First, the UTRAN checks whether UE1 and UE2 are camping on the same cell according to the registry information and position information of UE1 and UE2; then, the UTRAN computes whether the distance between the two UEs falls within the radio range supported by P2P communication, according to the position information of UE1 and UE2.

6. If not within the radio range supported by P2P communication (S19)

If UE1 and UE2 are not camping on the same cell or the computation result shows that the distance between UE1 and UE2 is out of the radio range supported by P2P communication, the UTRAN indicates UE1 and UE2 to communicate in conventional mode.

7. If within the radio range supported by P2P communication

When the two UEs are in the same cell and the distance between them is within the supported range of P2P communication, the UTRAN checks whether there is information for indicating the UEs' P2P communication capability (S16), and determines whether the two UEs both have P2P communication capability according to the information (S20).

7.1 When the UTRAN has the information for indicating the UE's P2P communication capability and the information indicates both UEs support P2P communication, the UTRAN allocates a direct communication link as radio resource (e.g. timeslot and spreading code) in the same way as conventional mode, (wherein the direct communication link includes two links, one is used for UE1 to send and UE2 to receive and the other is used for UE1 to receive and UE2 to send,) and enables UE1 and UE2 to enter direct communication mode. In direct communication mode, UE1 and UE2 exchange information with the set power via the allocated communication links (S21).

If the UTRAN itself doesn't have record information about whether the UE has P2P communication capability, it can acquire the information by polling.

7.2 When the UTRAN has the information for indicating whether the UE has P2P communication capability, but one of UE1 and UE2 doesn't have P2P communication capability, the UTRAN instructs UE1 and UE2 to communicate in conventional mode (S19).

7.3 When the UTRAN doesn't have the information for indicating whether the UE has P2P communication capability, it sends a poll message to the caller or the callee to query about whether the UE has P2P communication capability (S17). When UE1 or UE2 receives the poll message from the UTRAN, it responds to the UTRAN with information about its communication capability. Then the above steps in 7.1 and 7.2 will be reiterated.

It's to be noted additionally here that the information about whether the UE has P2P communication capability can be set by a keystroke or a switch on the UE, or determined by software in the UE (for instance, an item in setting menu). And the information for indicating P2P capability can be sent to the UTRAN in call request or call response.

The foregoing P2P communication method in conjunction with FIG. 4, can be implemented in software by modifying existing protocol messages for adding protocol messages, or in hardware, or in combination of software and hardware. When the above P2P communication method is implemented in hardware, the apparatus for P2P communication in the UTRAN and that in the UE, are composed respectively as follows:

During implementing P2P communication procedures, the apparatus for P2P communication in the UTRAN comprises: a call request responding unit, for receiving and responding to a call request when the call request sent by a caller to the UTRAN contains the position information of the caller; a paging response receiving unit, for receiving and responding to a call response when the call response sent by the callee to UTRAN contains the position information of the callee; a computing unit, for judging whether the two UEs (caller and callee) are in the same cell according to the registry information and position information of the caller and the callee, and computing whether the distance between them meets the scope requirement for P2P communication; a judging unit, for determining whether the two UEs both have P2P communication capability according to the information of the UTRAN indicating whether the caller and the callee both have P2P communication capability, when the two UEs are in the same cell and the distance between them meets the requirement for P2P communication; an allocating unit, for allocating direct communication link for the two UEs to perform P2P communication when the caller and the callee both have P2P communication capability. Furthermore, the apparatus for P2P communication may also include: a poll message sending unit, for sending a poll message to the caller or the callee to query whether the UEs have P2P communication capability, when the UTRAN doesn't have the information indicating whether the caller and the callee have P2P communication capability; an indication sending unit, for sending an indication to let the two UEs to communicate in conventional mode when the two UEs are not in the same cell or the distance between them doesn't meet the scope requirement for P2P communication or one of them doesn't have P2P communication capability. During the implementation of P2P communication procedures, the UE comprises: a calling unit, for sending a call request containing the position information of the UE to the UTRAN when the UE acts as a caller; a responding unit, for sending a call response containing the position information of the UE to the UTRAN when the UE acts as a callee; an RF unit, for receiving or transmitting radio signals; a data processing unit, for processing radio signals received by the RF unit and signals to be transmitted by the RF unit; a baseband processing unit, for controlling the RF unit and the data processing unit to directly communicate via the allocated direct communication link, after the UTRAN allocates direct communication link to it according to the registry information and position information of the UE and the information of the UTRAN about the P2P communication capability of the UE. Furthermore, the UE may also include: a poll message responding unit, for sending a message indicating whether the UE has P2P communication capability when receiving a poll message sent by the UTRAN to inquire whether the UE has P2P communication capability; a capability indicating means, for indicating whether the UE has P2P communication capability, wherein the capability indicating means can be a keystroke or a switch on the UE, or an item in setting menu in the UE.

### Beneficial Use of the Invention

As described above, the P2P communication method and apparatus used in TDD CDMA systems proposed by this invention can save about 50% radio resource for communication between two UEs who are very near with each other, compared with conventional communication mode. And the implementation of this invention only involves modifications to the higher-layer software modules of existing communication systems, which greatly reuses the hardware modules of existing communication systems.

Meanwhile, control link still exists between the UE and the UTRAN during P2P communication. Therefore the UTRAN can still keep control over the P2P communication, especially over the use of radio resource, so that network operators can easily charge for the radio resource used by the P2P communication.

1. A method for wireless communication systems to establish P2P (peer-to-peer) communication, comprising:
determining whether the two user equipments (caller and callee) are in the same cell and computing whether the distance between the two user equipments (UE) meets the requirement for P2P communication, according to the registry information and position information of the caller and the callee;
determining whether said two UEs both have P2P communication capability according to the information of the wireless communication system indicating whether said caller and said callee both have P2P communication capability, when said two UEs are in the same cell and the distance between the two UEs meets the requirement for P2P communication;
allocating direct communication link for said two UEs to perform P2P communication when the caller and the callee both have P2P communication capability.

2. The method for establishing P2P communication according to claim 1, wherein the position information of said caller is included in the call request sent by said caller to the wireless communication system.

3. The method for establishing P2P communication according to claim 1, wherein the position information of said callee is included in the call response sent by said callee to the wireless communication system.

4. The method for establishing P2P communication according to claim 1, when the wireless communication system doesn't have the information indicating whether said caller and said callee have P2P communication capability, further comprising:
sending a poll message to said caller or said callee to inquire whether the UE has P2P communication capability.

5. The method for establishing P2P communication according to claim 1, when the two UEs are not in the same cell or the distance between the two UEs doesn't meet the scope requirement for P2P communication or one of the two UEs doesn't have P2P communication capability, further comprising:
sending an instruction to indicate said two UEs to communicate in conventional mode.

6. A method for a user equipment to establish P2P communication, comprising:
communicating directly via an allocated direct communication link after the wireless communication system allocates direct communication link for it, according to the registry information, position information of the UE and the information of the wireless communication system about the P2P communication capability of the UE.

7. The method for establishing P2P communication according to claim 6, wherein the position information of said UE is included in the call request sent by the UE to the wireless communication system.

8. The method for establishing P2P communication according to claim 6, wherein the position information of said UE is included in the call response sent by the UE to the wireless communication system.

9. The method for establishing P2P communication according to claim 6, further comprising:
sending a message indicating whether said UE has P2P communication capability to the wireless communication system, by controlling a key-switch in the UE or selecting menu options set in the UE, when receiving a poll message from the wireless communication system to inquire whether said UE has P2P communication capability.

10. An apparatus for wireless communication systems to establish P2P communication, comprising:
a computing unit, for judging whether the two UEs (caller and callee) are in the same cell and computing whether the distance between the two UEs meets the scope requirement for P2P communication, according to the registry information and position information of the caller and the callee;
a judging unit, for determining whether the two UEs both have P2P communication capability according to the information of the wireless communication system indicating whether the caller and the callee both have P2P communication capability, when the two UEs are in the same cell and the distance between the two UEs meets the requirement for P2P communication;
an allocating unit, for allocating direct communication link for the two UEs to start P2P communication when the caller and the callee both have P2P communication capability.

11. The apparatus for establishing P2P communication according to claim 10, further comprising:
a call request responding unit, for receiving and responding to a call request when the call request sent by a caller to the wireless communication system includes the position information of the caller.

12. The apparatus for establishing P2P communication according to claim 10, further comprising:
a paging response receiving unit, for receiving and responding to a call response when the call response sent by the callee to the wireless communication system includes the position information of the callee.

13. The apparatus for establishing P2P communication according to claim 10, further comprising:
a poll message sending unit, for sending a poll message inquiring whether the UE have P2P communication capability to the caller or the callee, when the wireless communication system doesn't have information indicating whether the caller and the callee have P2P communication capability.

14. The apparatus for establishing P2P communication according to claim 10, further comprising:
an instruction sending unit, for sending an instruction to indicate the two UEs to communicate in conventional mode when the two UEs are not in the same cell or the distance between the two UEs doesn't meet the scope requirement for P2P communication or one of the two UEs doesn't have P2P communication capability.

15. A user equipment, comprising:
a RF unit, for receiving or transmitting radio signals;
a data processing unit, for processing radio signals received by said RF unit and signals to be transmitted by said RF unit;
a base-band processing unit, for controlling said RF unit and said data processing unit to directly communicate via the allocated direct communication link, after the wireless communication system allocates direct communication link to it according to the registry information and position information of the UE and the information of the wireless communication system about the P2P communication capability of the UE.

16. The user equipment according to claim 15, further comprising:
a calling unit, for sending a call request which including the position information of said UE to the wireless communication system when said user equipment acts as a caller.

17. The user equipment according to claim 15, further comprising:
a responding unit, for sending a call response including the position information of said UE to the wireless communication system when said UE acts as a callee.

18. The user equipment according to claim 15, further comprising:
a poll message responding unit, for sending a message indicating whether said UE has P2P communication capability when receiving a poll message from the wireless communication system to inquire whether said UE has P2P communication capability.

19. The user equipment according to claim 15, wherein said user equipment includes a keystroke representing whether said UE has P2P communication capability.
